(19) United States
(12) Patent Application Publication
(10) Pub. No.: US 2026/0105157 A1
(43) Pub. Date: Apr. 16, 2026

(54) IDENTIFICATION OF ACCESS AUTHORIZATION PLUGGIN VULNERABILITY

(71) Applicant: International Business Machines Corporation, Armonk, NY (US)

(72) Inventors: Yan Huang, Beijing (CN); Jiang Yi Liu, Beijing (CN); Heng Wang, Beijing (CN); Xiao Ling Chen, Beijing (CN); Bao Zhang, Beijing (CN)

(21) Appl. No.: 18/915,436

(22) Filed: Oct. 15, 2024

(51) Int. Cl. G06F 21/57

(52) U.S. Cl. CPC G06F 21/577; G06F 2221/033

(57) ABSTRACT

A method responds to a specific identified access authorization plugin vulnerability by identifying a set of client requests corresponding to the access authorization plugin vulnerability using a collector module of a container environment. The method generates a set of coverage reports based on the set of client requests by running the set of client requests in a test environment using a coverage report module of the container environment. The set of coverage reports including unique coverage reports corresponding to each client request in the set of client requests. The method analyzes each coverage report in the set of coverage reports using an analysis module of the container environment and updates at least one of a tactics module of the container environment and a source code of at least one access authorization plugin based on the analysis.

### BACKGROUND

The present invention generally relates to authorization plugin software, and more specifically, to a software process that identifies access authorization plugins with potential vulnerabilities.

An authorization plugin is a software process that approves or denies requests to a daemon such as a container daemon. Containers can provide ready-to-work authorization plugins that can use an engine to contact the daemon and run client commands and/or allow the creation and utilization of custom access authorization plugins.

### SUMMARY

Embodiments of the present invention are directed to a computer-implemented method for identifying access authorization plugins including potential vulnerabilities. A non-limiting example of the computer-implemented method includes a method that responds to a specific identified access authorization plugin vulnerability by identifying a set of client requests corresponding to the access authorization plugin vulnerability using a collector module of a container environment. The method generates a set of coverage reports based on the set of client requests by running the set of client requests in a test environment using a coverage report module of the container environment. The set of coverage reports including unique coverage reports corresponding to each client request in the set of client requests. The method analyzes each coverage report in the set of coverage reports using an analysis module of the container environment and updates at least one of a tactics module of the container environment and a source code of at least one access authorization plugin based on the analysis.

Embodiments of the present invention are further directed to systems, computer program products, and computer readable storage mediums for the same.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts a diagram illustrating a system for identifying authorization plugins including a potential vulnerability;

FIG. 3A depicts an operation flow where authorization of a plugin is allowed;

FIG. 3B depicts an operation flow where authorization of a plugin is denied;

FIG. 4 depicts an architecture for identifying and rectifying a potentially vulnerable authorization plugin; and

FIG. 5 depicts a process flow of the architecture of FIG. 4.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

In one example implementation, a computer-implemented method for responding to a specific identified access authorization plugin vulnerability in a container environment, the method includes identifying a set of client requests corresponding to the access authorization plugin vulnerability using a collector module of the container environment, generating a set of coverage reports based on the set of client requests by running the set of client requests in a test environment using a coverage report module of the container environment, the set of coverage reports including unique coverage reports corresponding to each client request in the set of client requests, analyzing each coverage report in the set of coverage reports using an analysis module of the container environment, and updating at least one of a tactics module of the container environment and a source code of at least one access authorization plugin based on the analysis. Implementation of the method allows identification of, and correction of, access authorization plugins including similar vulnerabilities to a specifically identified vulnerability.

In another example, identifying a set of client requests corresponding to the access authorization plugin vulnerability includes converting the specific identified access authorization plugin vulnerability to an abstract vulnerability trigger request and providing the abstract vulnerability trigger request to the collector module. Abstracting the vulnerability trigger request allows a detected specific vulnerability to be extrapolated to other access authorization plugins that are not identical but may still be susceptible to the same vulnerability.

In another example, identifying a set of client requests corresponding to the access authorization plugin vulnerability includes identifying each client requests in a set of access authorization plugins matching the identified abstract vulnerability trigger request. Identifying each client request allows the method to identify a set of all client requests susceptible to the vulnerability, and thereby allows the response to be targeted to the vulnerability.

In another example, the set of access authorization plugins includes at least five access authorization plugins, thereby allowing the automated detection and correction to be applied to a larger set of access authorization plugins.

In another example, each coverage report includes a line coverage entry identifying a ratio of lines executed of source code of the access authorization plugin corresponding to the client request of the coverage report to a total number of lines of the source code of the access authorization plugin corresponding to the client request of the coverage report, a branch coverage entry identifying execution of all branches in the source code of the access authorization plugin corresponding to the client request of the coverage report and indicating whether each branch is covered by a test case, a function coverage identifying a percentage of all functions and methods defined in the source code of the access authorization plugin corresponding to the client request of the coverage report that are called, a path coverage identifying how all possible paths are covered during code execution of the source code of the access authorization plugin corresponding to the client request of the coverage report, and an entry indicating all source code of the access authorization plugin corresponding to the client request of the coverage report not covered. Coverage reports including these elements allow the method to more specifically define the coverage, and improve the ability of the method to identify the specific portions of the access authorization plugin that may be susceptible to the vulnerability.

In another example, the analysis identifies hit modules and lines of each access authorization plugin in the set of access authorization plugins. Identification of the hit modules and lines further targets the analysis at the specific portions of the access authorization plugin that are vulnerable.

In yet another example, updating the at least one of the tactics module of the container environment and the source code of at least one access authorization plugin based on the analysis comprises updating the tactics module to prevent the at least one access authorization plugin from granting access in response to the source code of the at least one access authorization plugin being unable to be modified. Preventing the at least one access authorization plugin from granting access allows the method to minimize vulnerabilities that may not be able to be automatically corrected.

In another example, updating at least one of a tactics module of the container environment and the source code of the at least one access authorization plugin based on the analysis comprises updating the source code of the at least one access authorization plugin and verifying that the access authorization plugin is capable of preventing client commands including the vulnerability by operating the client commands including the vulnerability using the at least one access authorization plugin in a test environment.

In another example implementation, a computer program product stores instructions for implementing the computer-implemented method for responding to a specific identified access authorization plugin vulnerability in a container environment, the method includes identifying a set of client requests corresponding to the access authorization plugin vulnerability using a collector module of the container environment, generating a set of coverage reports based on the set of client requests by running the set of client requests in a test environment using a coverage report module of the container environment, the set of coverage reports including unique coverage reports corresponding to each client request in the set of client requests, analyzing each coverage report in the set of coverage reports using an analysis module of the container environment, and updating at least one of a tactics module of the container environment and a source code of at least one access authorization plugin based on the analysis. The computer program product allows for easier, and quicker, distribution of the computer implemented method to multiple systems.

In another example, identifying a set of client requests corresponding to the access authorization plugin vulnerability includes converting the specific identified access authorization plugin vulnerability to an abstract vulnerability trigger request and providing the abstract vulnerability trigger request to the collector module. Abstracting the vulnerability trigger request allows a detected specific vulnerability to be extrapolated to other access authorization plugins that are not identical but may still be susceptible to the same vulnerability.

In another example, identifying a set of client requests corresponding to the access authorization plugin vulnerability includes identifying each client requests in a set of access authorization plugins matching the identified abstract vulnerability trigger request. Identifying each client request allows the method to identify a set of all client requests susceptible to the vulnerability, and thereby allows the response to be targeted to the vulnerability.

In another example, the set of access authorization plugins includes at least five access authorization plugins, thereby allowing the automated detection and correction to be applied to a larger set of access authorization plugins.

In another example, each coverage report includes a line coverage entry identifying a ratio of lines executed of source code of the access authorization plugin corresponding to the client request of the coverage report to a total number of lines of the source code of the access authorization plugin corresponding to the client request of the coverage report, a branch coverage entry identifying execution of all branches in the source code of the access authorization plugin corresponding to the client request of the coverage report and indicating whether each branch is covered by a test case, a function coverage identifying a percentage of all functions and methods defined in the source code of the access authorization plugin corresponding to the client request of the coverage report that are called, a path coverage identifying how all possible paths are covered during code execution of the source code of the access authorization plugin corresponding to the client request of the coverage report, and an entry indicating all source code of the access authorization plugin corresponding to the client request of the coverage report not covered. Coverage reports including these elements allow the method to more specifically define the coverage, and improve the ability of the method to identify the specific portions of the access authorization plugin that may be susceptible to the vulnerability.

In another example, the analysis identifies hit modules and lines of each access authorization plugin in the set of access authorization plugins. Identification of the hit modules and lines further targets the analysis at the specific portions of the access authorization plugin that are vulnerable.

In yet another example, updating the at least one of the tactics module of the container environment and the source code of at least one access authorization plugin based on the analysis comprises updating the tactics module to prevent the at least one access authorization plugin from granting access in response to the source code of the at least one access authorization plugin being unable to be modified. Preventing the at least one access authorization plugin from granting access allows the method to minimize vulnerabilities that may not be able to be automatically corrected.

In another example, updating at least one of a tactics module of the container environment and the source code of the at least one access authorization plugin based on the analysis comprises updating the source code of the at least one access authorization plugin and verifying that the access authorization plugin is capable of preventing client commands including the vulnerability by operating the client commands including the vulnerability using the at least one access authorization plugin in a test environment.

In another example implementation, a system includes a computer having a processor set and a memory. The memory stores instructions for causing the processor set to perform operations including: identifying a set of client requests corresponding to the access authorization plugin vulnerability using a collector module of the container environment, generating a set of coverage reports based on the set of client requests by running the set of client requests in a test environment using a coverage report module of the container environment, the set of coverage reports including unique coverage reports corresponding to each client request in the set of client requests, analyzing each coverage report in the set of coverage reports using an analysis module of the container environment, and updating at least one of a tactics module of the container environment and a source code of at least one access authorization plugin based on the analysis. The computer program product allows for easier, and quicker, distribution of the computer implemented method to multiple systems.

In another example, identifying a set of client requests corresponding to the access authorization plugin vulnerability includes converting the specific identified access authorization plugin vulnerability to an abstract vulnerability trigger request and providing the abstract vulnerability trigger request to the collector module. Abstracting the vulnerability trigger request allows the vulnerabilities to be identified in similar, but not identical, structures.

In another example, identifying a set of client requests corresponding to the access authorization plugin vulnerability comprises identifying each client requests in a set of access authorization plugins matching the identified abstract vulnerability trigger request. Identifying each client request allows the method to identify a set of all client requests susceptible to the vulnerability, and thereby allows the response to be targeted to the vulnerability.

In another example, each coverage report includes a line coverage entry identifying a ratio of lines executed of source code of the access authorization plugin corresponding to the client request of the coverage report to a total number of lines of the source code of the access authorization plugin corresponding to the client request of the coverage report, a branch coverage entry identifying execution of all branches in the source code of the access authorization plugin corresponding to the client request of the coverage report and indicating whether each branch is covered by a test case, a function coverage identifying a percentage of all functions and methods defined in the source code of the access authorization plugin corresponding to the client request of the coverage report that are called, a path coverage identifying how all possible paths are covered during code execution of the source code of the access authorization plugin corresponding to the client request of the coverage report, and an entry indicating all source code of the access authorization plugin corresponding to the client request of the coverage report not covered. Coverage reports including these elements allow the method to more specifically define the coverage, and improve the ability of the method to identify the specific portions of the access authorization plugin that may be susceptible to the vulnerability.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as automatically identifying authorization plugins including potential vulnerabilities at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 132, virtual machine set 143, and container set 144.

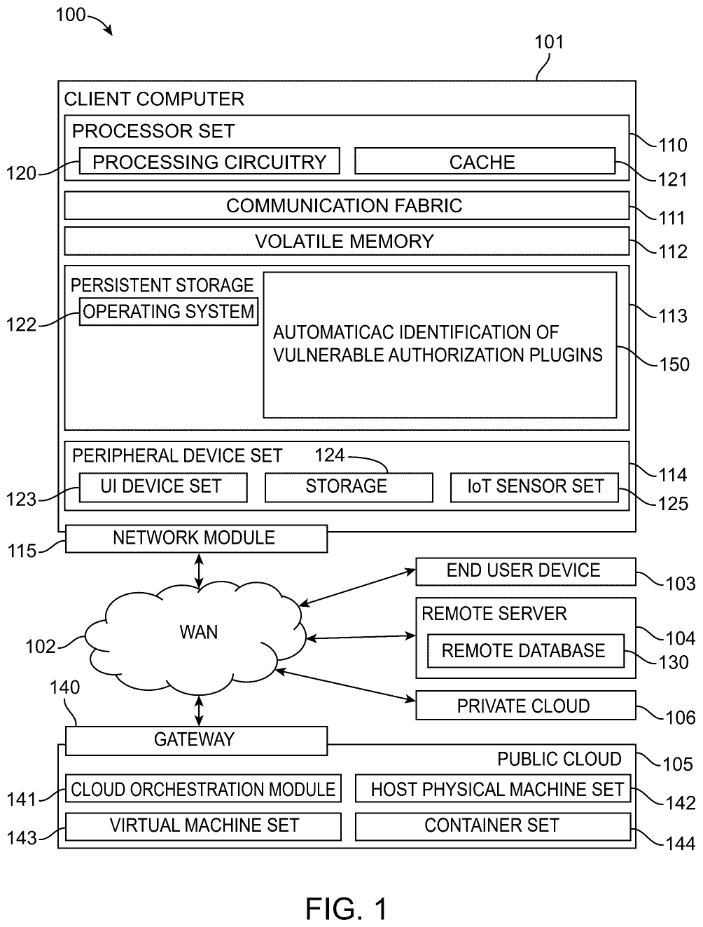

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, ready-to-work authorization models, such as the model used in a DOCKER® environment, are based in caller/user with permission to access the daemon can use any engine application programming interface (API) to contact the Docker daemon or run any Docker client command. If the environment requires greater access control authorization plugins are created and added to the daemon configuration.

Before developing an access authorization plugin, or using an available access authorization plugin, a plugin developer or an administrator configures granular access policies for managing access to the daemon. The set of granular access policies are referred to as access tactics (or tactics) and are implemented using a tactics module. While plugins are generally easy to develop and acquire, it is difficult and complex to create an effective and full access tactic that allows desirable access while preventing undesirable access such as access through a vulnerability. Currently development of such a tactic relies on the personal experiences of the plugin developer and the administrator. Exacerbating this difficulty is the number of different access authorization plugins that are utilized within a given environment, and the miniscule amount of time between discovery of an access vulnerability and when the access vulnerability needs to be corrected.

Methods exist for creating general tactics for the operation of access authorization plugins in large scale environments automatically. When created, these tactics are implemented through a tactics module according to a conventional process.

When a vulnerability is discovered, the time available for responding to the vulnerability (the response time) is substantially short, making it challenging to locate and fix all authorization plugins, especially those related to permissions that are subject to the vulnerability, before the vulnerability is exploited. Embodiments of the disclosed systems and processes provide a method to automatically and quickly locate access plugins including a discovered vulnerability in the environment, or any other similar daemon architecture. Manually reviewing each access authorization plugin to determine if the plugin is susceptible to the vulnerability takes a substantial amount of time and cannot be performed in the required response time. One example method automatically creates new test cases to verify the problem of tactics for access authorization plugins and to find any similar problems, and then add these new test cases into an existing test framework, thereby allowing the existing test framework to be updated for the newly identified vulnerability.

The example method prevents client commands from utilizing vulnerabilities by initially filtering the vulnerabilities and collecting the responding client requests. Then, the process generates coverage reports by running the client request, and analyzes the coverage reports to locate any vulnerabilities in the environment. Then the process verifies if access authorization plugins can prevent the client command from operating and if the access authorization plugins cannot prevent the client command from operating, the method updates the code of the plugins and/or the tactics.

The above-described aspects of the invention address the shortcomings of the prior art by quickly and automatically identifying potential vulnerabilities and

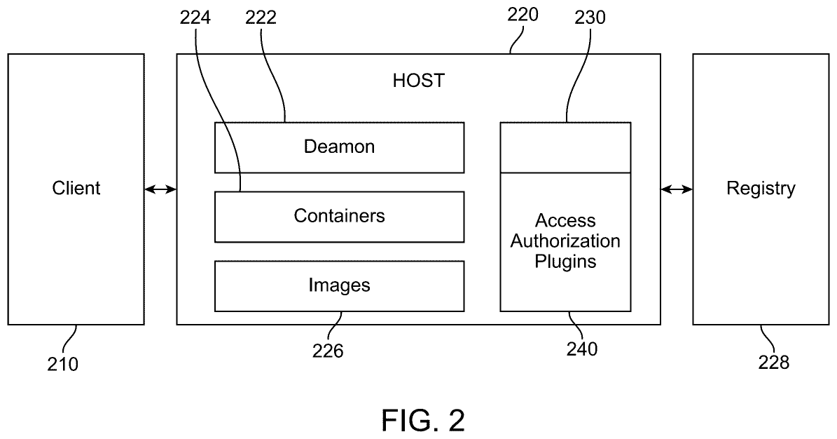

Turning now to a more detailed description of aspects of the present invention, FIG. 2 depicts a system 200 for identifying authorization plugins including a potential vulnerability according to embodiments of the invention. The system 200 includes a host 220 which hosts a runtime environment for containerized applications and programs. A daemon 222 manages the image build and manages deployment of container images 226 based on instructions received from a client 210. The container images 226 are used to instantiate or launch containers 224. In some embodiments, the container images 226 is held within a registry 228. The host 220 also provides access management to resources of the runtime environment including namespaces, network paths, hosts, and the like. The access may be based on access policies that are stored in one or more authorization plugins 240.

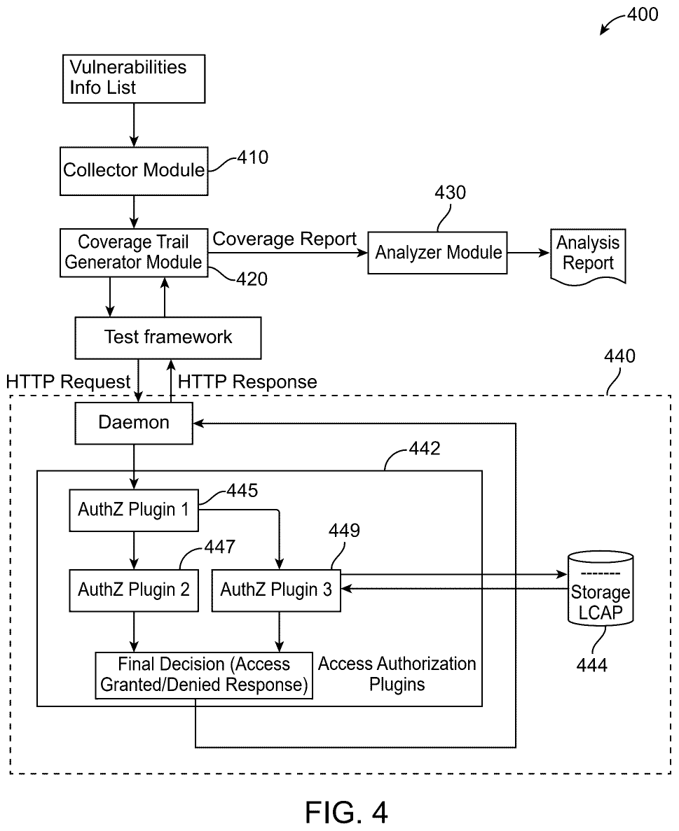

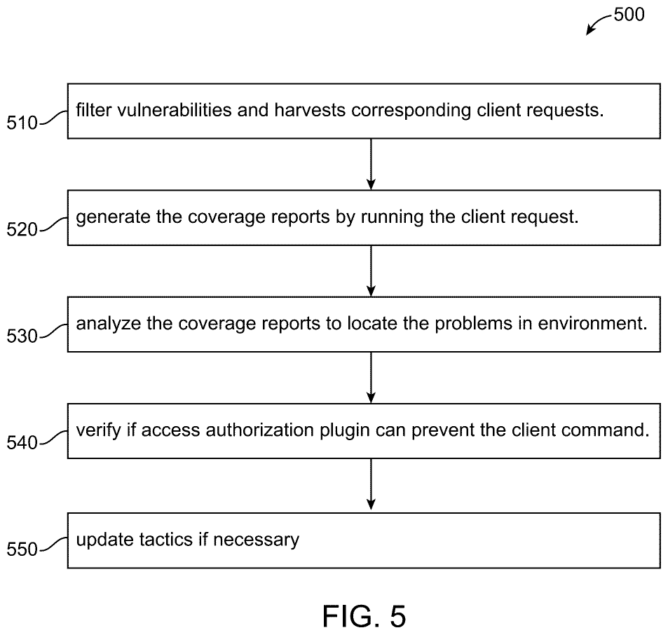

The host 220 further includes a vulnerability detector 230, which is described with regards to FIGS. 4 and 5.

The vulnerability detector 230 generally responds to an identified vulnerability within one of the one or more authorization plugins by identifying similarly structured authorization plugins as potentially including the same or similar vulnerability and preventing the system 200 from allowing such authorization plugins to provide access.

According to various embodiments, the host 220 may also include a policy generator. The policy generator is configured to identify user groups within the runtime environment of the host 220 and access restrictions that are assigned to the user groups. Each user group may have a different set of access restrictions with respect to the resources within the runtime environment. It should be appreciated that the user groups may have the same set of access restrictions, partially overlapping sets of access restrictions (where some of the restrictions are common among each and some are different), and the like.

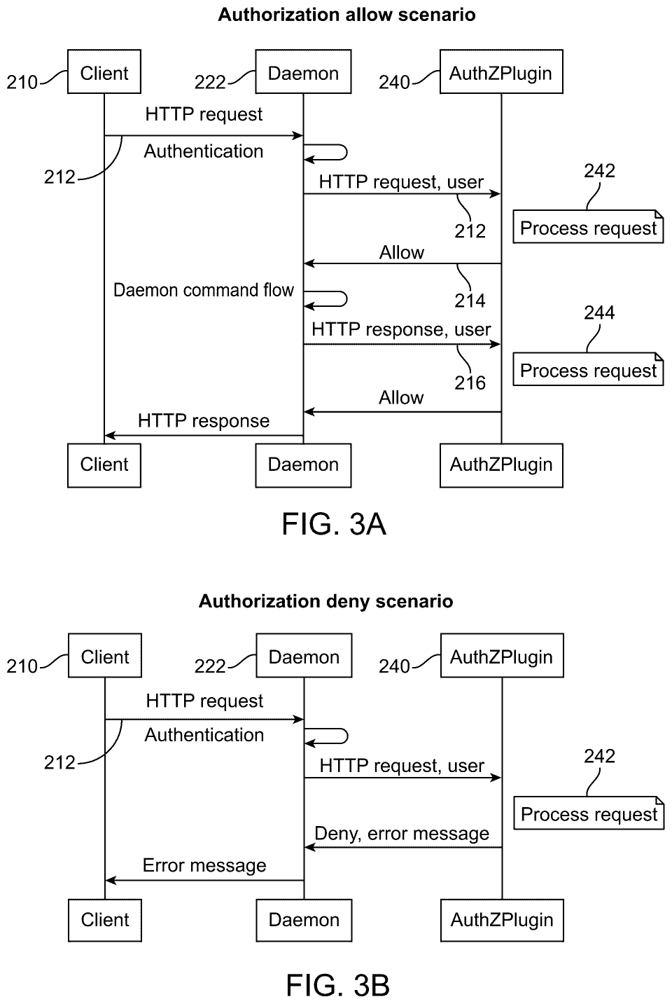

With continued reference to FIGS. 1 and 2, FIG. 3A illustrates an example operation flow of the system 200 when an authorization plugin is granted access, and FIG. 3B illustrates an example operation flow of the system 200 when the authorization plugin is not granted access. In both cases, the client 210 initiates an http request 212 querying the daemon 222. The daemon 222 forwards the http request 212 to the plugin 240, where the http request 212 is processed via a processing module 242.

In the example of FIG. 3A, the authorization plugin 240 allows the request, and an “allow” 214 message is provided back to the daemon 222. The daemon 214 then processes a command flow based on the http request 212 and provides an http response 216 to the authorization plugin 240. The authorization plugin 240 the processes the response in a processing module 244 and provides the response back to the client 210 through the daemon 222.

In contrast, when the initial processing module 242 determines that the request is not authorized, an error message 218 is provided back to the client 210 and access is prevented. As can be appreciated from this process flow, when a vulnerability allows access through the authorization plugin, a client command can access information and resources, and exert controls, that the originator of the client command is not authorized to access or exert.

With continued reference to the general system described at FIGS. 1-3B, FIG. 4 illustrates a top level design 400 for automatically identifying and addressing vulnerable access authorization plugins.

The core operation of the top level design 400 locates vulnerable access authorization plugins automatically and quickly. In some cases, the vulnerability is prevented from allowing access (by updating the tactics) and in other cases the vulnerability is corrected by automatically updating a code of the access authorization plugin.

Initially, a collector module 410 receives a set of known vulnerabilities, including the newly identified vulnerability and harvests all client requests associated with the vulnerabilities. The collector module 410 functions as a sieve, filtering through known vulnerabilities to collect any client requests that exploit the known vulnerability. This filtering ensures that only pertinent data is gathered for further analysis.

The collected client requests are provided to a coverage trail generator module 420 which generates comprehensive reports describing the vulnerabilities by executing the collected client requests using a test framework 440. The test framework 440 uses an authorization plugin architecture 442 to connect through relevant access authorization plugins 444 and make a decision on whether access to the client request should be granted. While the illustrated example uses three authorization plugins 445, 447, 449 from the set of authorization plugins 444, it is appreciated that practical implementations may utilize any number of plugins in any appropriate configuration. In one example, the set of authorization access plugins 444 includes at least five to twenty access authorization plugins.

The executed client requests are monitored and collected to generate a report which maps out (describes) the execution path of each client request. The reports further describe how the environment is affected by each request.

The reports are consolidated and provided to an analyzer module 430. The analyzer module 430 analyzes the coverage reports and identifies problems within the environment, verifies the effectiveness of the access authorization plugins at preventing improper access, and updates a tactics module and/or modifies the source code of the access authorization plugin when an update is required.

With continued reference to FIGS. 1-4, FIG. 5 illustrates the process flow 500 of FIG. 4 as a process 500.

Initially, vulnerabilities are filtered, and the corresponding client requests are harvested in a harvest step 510 using the collector module 410. The harvest step 510 further converts the specific identified vulnerabilities that are found into abstract vulnerability trigger requests, and provides the abstract vulnerability trigger requests to the coverage generator module 420. Converting the specific identified vulnerability into an abstract vulnerability trigger request allows the vulnerability analysis to be generalized from the specific access authorization plugin to all general access authorization plugins.

The coverage generator module 420 runs the client requests and generates coverage reports in a generate reports step 520. One coverage report is generated for every access authorization plugin that is tested, with the coverage reports including information related to the execution of the plugin's code. In one example, each coverage report includes a line coverage entry showing the ratio of lines executed in the code under test to the total number of lines (expressed as a percentage), a branch coverage entry showing the execution of all branches (such as if or when conditions) in the code and indicating whether each branch is covered by the test case, a function coverage showing the percentage of all functions or methods defined in the code that are called, a path coverage showing how all possible paths are covered during code execution, and a code not covered entry.

In one example, the report for each authorization plugin can take the form of Table 1:

| Name | Stmts | Miss | Cover | Missing(LINE NO.) |
|---|---|---|---|---|
| plugin1.go | 6 | 1 | 83% | 10 |
| plugin2.go | 10 | 0 | 100% | |
| TOTAL | 6 | 1 | 94% | |

The generate reports step 520 then passes the generated reports to the analyzer module 430. The analyzer module 430 analyzes the coverage reports in an analyze reports step 530. The analysis uses the coverage reports to locate hit modules and lines. As used herein, a hit module and line refers to the modules and lines of code that have been covered or executed during testing for generating coverage report. Existing test cases are filtered based on the coverage report for the hit module and the matching existing test cases are run to generate coverage reports of the test cases. The coverage reports of the test cases are compared with the coverage report from the coverage module 420 and any branches or paths within the authorization plugin that are not covered or are less covered are identified. As used herein a covered branch or path is one that is not subject to the vulnerability, a less covered branch or path is partially subject to the vulnerability, and a not covered branch or path is one that is fully vulnerable.

Once identified, new test cases are generated and coverage analysis is run on the not covered and/or less covered branches and the code of the authorization plugin is modified to ensure that the branch is fully covered in an iterative process.

Once the code is modified, the process 500 verifies that the access authorization plugin can prevent the client command including the vulnerability by operating the client command and the authorization plugin in the test environment in a verify prevention step 540. When the updated authorization plugin successfully prevents access of the client command including the vulnerability, the verify prevention step 550 updates the tactics module to include the updated authorization plugin and the process 500 ends.

In the event that the code cannot be modified to prevent access, the tactics are adjusted to prevent the access authorization plugin from allowing access.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for responding to a specific identified access authorization plugin vulnerability in a container environment, the method comprising:
identifying a set of client requests corresponding to the access authorization plugin vulnerability using a collector module of the container environment;
generating a set of coverage reports based on the set of client requests by running the set of client requests in a test environment using a coverage report module of the container environment, the set of coverage reports including unique coverage reports corresponding to each client request in the set of client requests;
analyzing each coverage report in the set of coverage reports using an analysis module of the container environment; and
updating at least one of a tactics module of the container environment and a source code of at least one access authorization plugin based on the analysis.

2. The computer-implemented method of claim 1, wherein identifying a set of client requests corresponding to the access authorization plugin vulnerability comprises converting the specific identified access authorization plugin vulnerability to an abstract vulnerability trigger request and providing the abstract vulnerability trigger request to the collector module.

3. The computer-implemented method of claim 2, wherein identifying a set of client requests corresponding to the access authorization plugin vulnerability comprises identifying each client requests in a set of access authorization plugins matching the identified abstract vulnerability trigger request.

4. The computer-implemented method of claim 3, wherein the set of access authorization plugins includes at least five access authorization plugins.

5. The computer-implemented method of claim 2, wherein each coverage report includes a line coverage entry identifying a ratio of lines executed of source code of the access authorization plugin corresponding to the client request of the coverage report to a total number of lines of the source code of the access authorization plugin corresponding to the client request of the coverage report, a branch coverage entry identifying execution of all branches in the source code of the access authorization plugin corresponding to the client request of the coverage report and indicating whether each branch is covered by a test case, a function coverage identifying a percentage of all functions and methods defined in the source code of the access authorization plugin corresponding to the client request of the coverage report that are called, a path coverage identifying how all possible paths are covered during code execution of the source code of the access authorization plugin corresponding to the client request of the coverage report, and an entry indicating all source code of the access authorization plugin corresponding to the client request of the coverage report not covered.

6. The computer-implemented method of claim 2, wherein the analysis identifies hit modules and lines of each access authorization plugin in the set of access authorization plugins.

7. The computer-implemented method of claim 2, wherein updating the at least one of the tactics module of the container environment and the source code of at least one access authorization plugin based on the analysis comprises updating the tactics module to prevent the at least one access authorization plugin from granting access in response to the source code of the at least one access authorization plugin being unable to be modified.

8. The computer-implemented method of claim 2, wherein updating at least one of a tactics module of the container environment and the source code of the at least one access authorization plugin based on the analysis comprises updating the source code of the at least one access authorization plugin and verifying that the access authorization plugin is capable of preventing client commands including the vulnerability by operating the client commands including the vulnerability using the at least one access authorization plugin in a test environment.

9. A computer program product comprising a non-transitory computer readable medium storing instructions for implementing a method for responding to a specific identified access authorization plugin vulnerability in a container environment, the method comprising:
identifying a set of client requests corresponding to the access authorization plugin vulnerability using a collector module of the container environment;
generating a set of coverage reports based on the set of client requests by running the set of client requests in a test environment using a coverage report module of the container environment, the set of coverage reports including unique coverage reports corresponding to each client request in the set of client requests;
analyzing each coverage report in the set of coverage reports using an analysis module of the container environment; and
updating at least one of a tactics module of the container environment and a source code of at least one access authorization plugin based on the analysis.

10. The computer program product of claim 9, wherein identifying a set of client requests corresponding to the access authorization plugin vulnerability comprises converting the specific identified access authorization plugin vulnerability to an abstract vulnerability trigger request and providing the abstract vulnerability trigger request to the collector module.

11. The computer program product of claim 10, wherein identifying a set of client requests corresponding to the access authorization plugin vulnerability comprises identifying each client requests in a set of access authorization plugins matching the identified abstract vulnerability trigger request.

12. The computer program product of claim 11, wherein the set of access authorization plugins includes at least five access authorization plugins.

13. The computer program product of claim 10, wherein each coverage report includes a line coverage entry identifying a ratio of lines executed of source code of the access authorization plugin corresponding to the client request of the coverage report to a total number of lines of the source code of the access authorization plugin corresponding to the client request of the coverage report, a branch coverage entry identifying execution of all branches in the source code of the access authorization plugin corresponding to the client request of the coverage report and indicating whether each branch is covered by a test case, a function coverage identifying a percentage of all functions and methods defined in the source code of the access authorization plugin corresponding to the client request of the coverage report that are called, a path coverage identifying how all possible paths are covered during code execution of the source code of the access authorization plugin corresponding to the client request of the coverage report, and an entry indicating all source code of the access authorization plugin corresponding to the client request of the coverage report not covered.

14. The computer program product of claim 10, wherein the analysis identifies hit modules and lines of each access authorization plugin in the set of access authorization plugins.

15. The computer program product of claim 10, wherein updating the at least one of the tactics module of the container environment and the source code of at least one access authorization plugin based on the analysis comprises updating the tactics module to prevent the at least one access authorization plugin from granting access in response to the source code of the at least one access authorization plugin being unable to be modified.

16. The computer program product of claim 10, wherein updating at least one of a tactics module of the container environment and the source code of the at least one access authorization plugin based on the analysis comprises updating the source code of the at least one access authorization plugin and verifying that the access authorization plugin is capable of preventing client commands including the vulnerability by operating the client commands including the vulnerability using the at least one access authorization plugin in a test environment.

17. A system comprising:
a computer including a processor set and a memory, the memory storing instructions for causing the processor set to perform operations comprising:
identifying vulnerable access authorization plugins by identifying a set of client requests corresponding to an access authorization plugin vulnerability using a collector module of a container environment;
generating a set of coverage reports based on the set of client requests by running the set of client requests in a test environment using a coverage report module of the container environment, the set of coverage reports including unique coverage reports corresponding to each client request in the set of client requests;
analyzing each coverage report in the set of coverage reports using an analysis module of the container environment; and
updating at least one of a tactics module of the container environment and a source code of at least one access authorization plugin based on the analysis.

18. The system of claim 17, wherein identifying a set of client requests corresponding to the access authorization plugin vulnerability comprises converting the specific identified access authorization plugin vulnerability to an abstract vulnerability trigger request and providing the abstract vulnerability trigger request to the collector module.

19. The system of claim 18, wherein identifying a set of client requests corresponding to the access authorization plugin vulnerability comprises identifying each client requests in a set of access authorization plugins matching the identified abstract vulnerability trigger request.

20. The system of claim 18, wherein each coverage report includes a line coverage entry identifying a ratio of lines executed of source code of the access authorization plugin corresponding to the client request of the coverage report to a total number of lines of the source code of the access authorization plugin corresponding to the client request of the coverage report, a branch coverage entry identifying execution of all branches in the source code of the access authorization plugin corresponding to the client request of the coverage report and indicating whether each branch is covered by a test case, a function coverage identifying a percentage of all functions and methods defined in the source code of the access authorization plugin corresponding to the client request of the coverage report that are called, a path coverage identifying how all possible paths are covered during code execution of the source code of the access authorization plugin corresponding to the client request of the coverage report, and an entry indicating all source code of the access authorization plugin corresponding to the client request of the coverage report not covered.
